(19) United States
(12) Patent Application Publication
(10) Pub. No.: US 2016/0035282 A1
(43) Pub. Date: Feb. 4, 2016

(54) Pixel Circuit for an Active-Matrix Organic Light-Emitting Diode Display

(71) Applicant: EverDisplay Optronics (Shanghai) Limited, Shanghai (CN)

(72) Inventors: Jiahao Lu, Shanghai (CN); Xin Mou, Shanghai (CN)

(73) Assignee: EverDisplay Optronics (Shanghai) Limited

(21) Appl. No.: 14/482,559

(22) Filed: Sep. 10, 2014

(30) Foreign Application Priority Data
Aug. 1, 2014 (CN) 201410376585.7

(51) Int. Cl. G09G 3/32; H05B 33/08

(52) U.S. Cl. CPC G09G 3/3258; H05B 33/0896

(57) ABSTRACT

A pixel circuit for an active-matrix organic light-emitting diode display including an organic light-emitting diode and a driving circuit. The driving circuit includes six switches, a driving transistor, and a capacitor. By compensating the threshold voltage of the driving transistor, the electric current flowing through the organic light-emitting diode can precisely be controlled without influence by the threshold voltage of the driving transistor, increasing the luminance uniformity and stability of the display. Furthermore, the present invention can be applied to a depletion mode driving transistor (i.e., an oxide TFT). Thus, the threshold voltage can be obtained to proceed with compensation no matter the threshold voltage of the driving transistor is larger or smaller than zero.

### CROSS-REFERENCE TO RELATED APPLICATION

The present invention claims the benefit of priority to CN 201410376585.7, filed on Aug. 1, 2014 with the State Intellectual Property Office of the People's Republic of China, the specification of which is incorporated herein in its entirety by reference.

### BACKGROUND OF THE INVENTION

The present invention relates to a pixel circuit for a display and, more particularly, to a pixel circuit for an active-matrix organic light-emitting diode display.

For an active-matrix organic light-emitting diode (AMOLED) display, its pixel circuit uses a thin-film transistor as an element to turn on/off and drive the AMOLED. However, the AMOLED display is driven by electric current and is, thus, very sensitive to the change of electric current. Threshold voltage Vₜₕ variation occurs during amorphous silicon (a-Si) processing of the thin-film transistor serving as the driving element. Although the a-Si processing has a high yield and the initial threshold voltages Vₜₕ are substantially the same, a drifting phenomenon, however, occurs in the threshold voltages Vₜₕ after a long period of operation, leading to a variation in the electric current. Thus, the threshold voltage Vₜₕ of the thin-film transistor (TFT) remained in the conductive state for a long period of time changes over time. The luminance uniformity and stability of the whole display are adversely and significantly affected.

To compensate the change in the threshold voltage Vₜₕ of the thin-film transistor (TFT), the threshold voltage Vₜₕ of the thin-film transistor (TFT) must be obtained first. FIGS. 1A, 1B, and 1C show the current methods for obtaining the threshold voltage Vₜₕ. However, during the a-Si processing of the thin-film transistor (TFT), the value of the threshold voltage Vₜₕ could be negative, particularly for a depletion mode oxide TFT. The compensation circuit shown in FIG. 1 is only suitable in a case that the threshold voltage Vₜₕ is larger than zero. Once the threshold voltage Vₜₕ is smaller than zero, the compensation circuit shown in FIG. 1 cannot compensate the variation of the threshold voltage Vₜₕ.

Thus, it is the research motive of the present invention to develop a pixel circuit for an active-matrix organic light-emitting diode display to solve the above drawbacks.

### BRIEF SUMMARY OF THE INVENTION

The technical problem to be solved by the present invention is solved by providing a pixel circuit for an active-matrix organic light-emitting diode display to compensate the threshold voltage variation of the driving transistor. The electric current flowing through the organic light-emitting diode can precisely be controlled without influence from the threshold voltage of the driving transistor, increasing the luminance uniformity and stability of the display.

An objective of the present invention is to provide a pixel circuit for an active-matrix organic light-emitting diode display to compensate the threshold voltage no matter the threshold voltage of the thin-film transistor (TFT) is larger or smaller than zero.

The fulfill the above technical effect, the present invention presents a pixel circuit for an active-matrix organic light-emitting diode display including an organic light-emitting diode and a driving circuit. The driving circuit includes an initialization module, a signal voltage writing module, and a light-emitting display module. The driving circuit further includes a threshold voltage compensation module, the threshold voltage compensation module includes a sixth switch and a driving transistor, and the sixth switch is used to obtain a threshold voltage of the driving transistor and to proceed with compensation of a variation of the threshold voltage, precisely controlling an electric current in the light-emitting display module flowing through the organic light-emitting diode.

Further improvement of the present invention includes: the initialization module includes a first switch and a second switch, the signal voltage writing module includes a fifth switch, and the light-emitting display module includes a third switch, a fourth switch, and a capacitor having a first capacitor end and a second capacitor end. Each of the first, second, third, fourth, fifth, and sixth switches and the driving transistor includes a first end, a second end, and a control end determining conduction of the first end and the second end. The first end of the first switch, the second end of the third switch, the first end of the fifth switch, and the first capacitor end of the capacitor are electrically connected to a first node. The second end of the first switch and the first end of the second switch are electrically connected to an initialization voltage. The control end of the first switch and the control end of the second switch are electrically connected to a first scan line. The second end of the second switch and the second end of the fourth switch are electrically connected to an anode of the organic light-emitting diode. The first end of the third switch, the second end of the sixth switch, and the control end of the driving transistor are electrically connected to a second node. The control end of the third switch and the control end of the fourth switch are electrically connected to an emission line. The first end of the fourth switch, the second end of the driving transistor, and the second capacitor end of the capacitor are electrically connected to a third node. The second end of the fifth switch is electrically connected to a data voltage. The control end of the fifth end and the control end of the sixth switch are electrically connected to a second scan line. The first end of the sixth switch is electrically connected to a sustaining voltage. The first end of the driving transistor is electrically connected to a first power voltage.

Further improvement of the present invention includes: each of the first, second, third, fourth, fifth, and sixth switches and the driving transistor is an N-type thin-film transistor. Preferably, the control end of each of the first, second, third, fourth, fifth, and sixth switches and the driving transistor is a gate of the N-type thin-film transistor.

Further improvement of the present invention includes: the first end of each of the first, second, third, fourth, fifth, and sixth switches and the driving transistor is a source or a drain of the N-type thin-film transistor. The second end of each of the first, second, third, fourth, fifth, and sixth switches and the driving transistor is the drain or the source of the N-type thin-film transistor. The second end is different from the first end.

Furthermore, to fulfill the above technical effect, the present invention also presents a pixel circuit for an active-matrix organic light-emitting diode display including:

an organic light-emitting diode including an anode and a cathode electrically connected to a second power voltage; and

a driving circuit including a first switch, a second switch, a third switch, a fourth switch, a fifth switch, a sixth switch, a driving transistor, and a capacitor, with the capacitor including a first capacitor end and a second capacitor end,

wherein each of the first, second, third, fourth, fifth, and sixth switches and the driving transistor includes a first end, a second end, and a control end determining conduction of the first end and the second end, wherein the first end of the first switch, the second end of the third switch, the first end of the fifth switch, and the first capacitor end of the capacitor are electrically connected to a first node, wherein the second end of the first switch and the first end of the second switch are electrically connected to an initialization voltage, wherein the control end of the first switch and the control end of the second switch are electrically connected to a first scan line, wherein the second end of the second switch and the second end of the fourth switch are electrically connected to the anode of the organic light-emitting diode, wherein the first end of the third switch, the second end of the sixth switch, and the control end of the driving transistor are electrically connected to a second node, wherein the control end of the third switch and the control end of the fourth switch are electrically connected to an emission line, wherein the first end of the fourth switch, the second end of the driving transistor, and the second capacitor end of the capacitor are electrically connected to a third node, wherein the second end of the fifth switch is electrically connected to a data voltage, wherein the control end of the fifth end and the control end of the sixth switch are electrically connected to a second scan line, wherein the first end of the sixth switch is electrically connected to a sustaining voltage, and wherein the first end of the driving transistor is electrically connected to a first power voltage.

Further improvement of the present invention includes: each of the first, second, third, fourth, fifth, and sixth switches and the driving transistor is an N-type thin-film transistor.

Further improvement of the present invention includes: the control end of each of the first, second, third, fourth, fifth, and sixth switches and the driving transistor is a gate of the N-type thin-film transistor.

Further improvement of the present invention includes: the first end of each of the first, second, third, fourth, fifth, and sixth switches and the driving transistor is a source or a drain of the N-type thin-film transistor. The second end of each of the first, second, third, fourth, fifth, and sixth switches and the driving transistor is the drain or the source of the N-type thin-film transistor. The second end is different from the first end.

The techniques, solutions, and other effects of the present invention for achieving the above objective will be described in details by reference to the accompanying drawings in connection with a preferred practicable embodiment.

### BRIEF DESCRIPTION OF THE DRAWINGS

FIG. 1A is a partial diagram illustrating obtaining of a threshold voltage Vₜₕ of a driving transistor by a current pixel compensation circuit.

FIG. 1B is a diagram illustrating a current method for obtaining the threshold voltage Vₜₕ of a driving transistor in a case that the threshold voltage Vₜₕ is larger than zero.

FIG. 1C is a diagram illustrating another current method for obtaining the threshold voltage Vₜₕ of a driving transistor in a case that the threshold voltage Vₜₕ is smaller than zero.

FIG. 2 is a circuitry diagram of a pixel circuit for an active-matrix organic light-emitting diode display according to the present invention.

FIG. 3 is a timing program of the pixel circuit for an active-matrix organic light-emitting diode display according to the present invention.

FIG. 4A is a partial diagram illustrating obtaining of a threshold voltage Vₜₕ of a driving transistor by the pixel compensation circuit according to the present invention.

FIG. 4B is a diagram illustrating a method for obtaining the threshold voltage Vₜₕ of a driving transistor according to the present invention in a case that the threshold voltage Vₜₕ is larger than zero.

FIG. 4C is a diagram illustrating another method for obtaining the threshold voltage Vₜₕ of a driving transistor according to the present invention in a case that the threshold voltage Vₜₕ is smaller than zero.

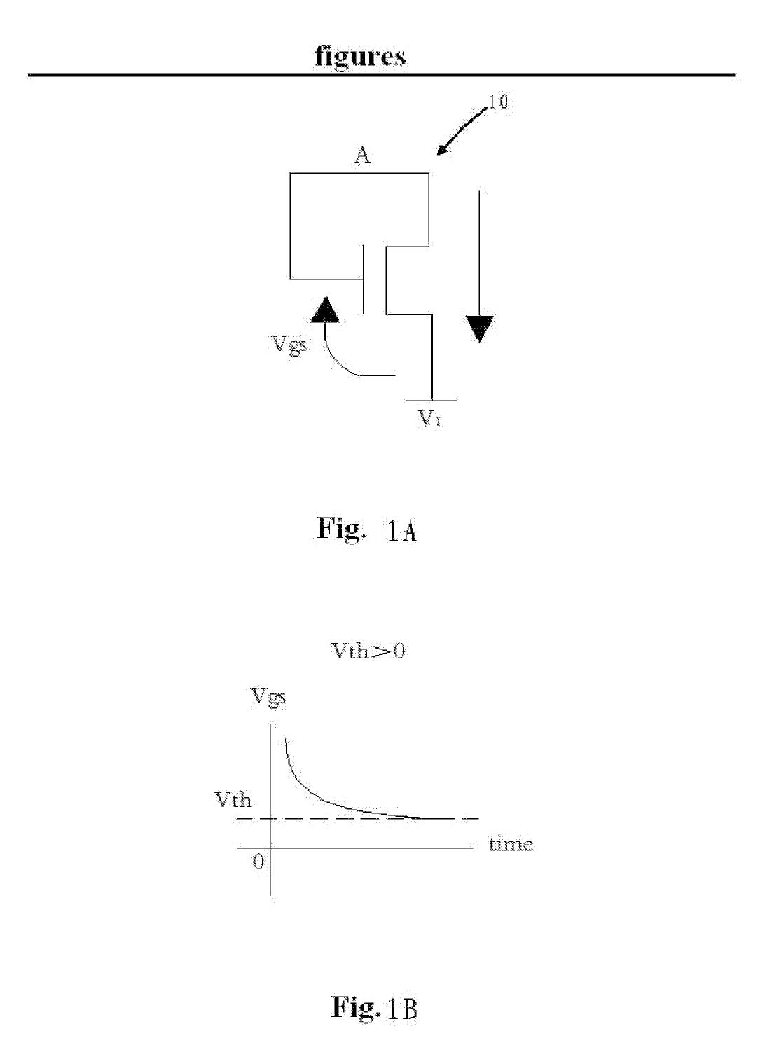

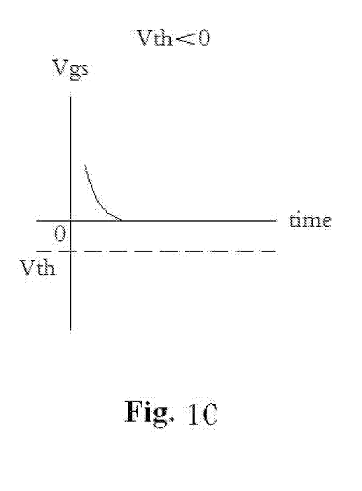

### DETAILED DESCRIPTION OF THE INVENTION

The present invention will be further described in connection with the accompanying drawings and specific embodiments.

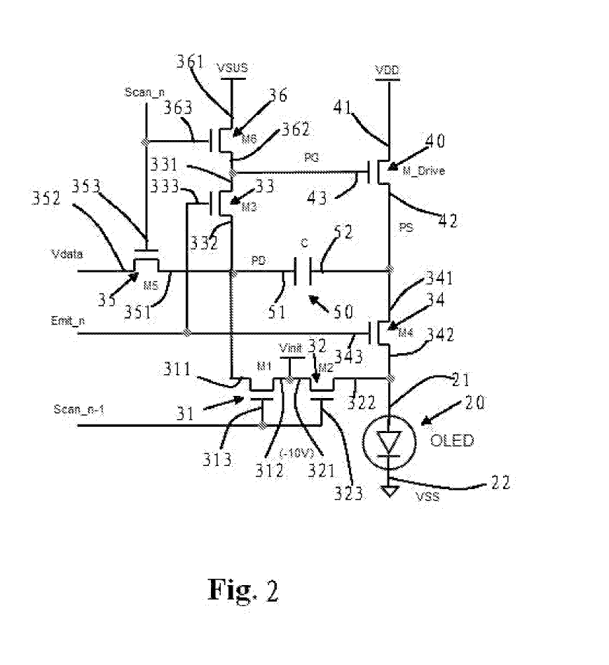

FIG. 2 is a circuitry diagram of a pixel circuit for an active-matrix organic light-emitting diode display according to the present invention including an organic light-emitting diode 20 and a driving circuit.

The organic light-emitting diode 20 includes an anode 21 and a cathode 22 electrically connected to a second power voltage BSS (namely, a negative terminal of the power).

The driving circuit includes a first switch 31, a second switch 32, a third switch 33, a fourth switch 34, a fifth switch 35, a sixth switch 36, a driving transistor 40, and a capacitor 50 having a first capacitor end 51 and a second capacitor end 52.

Each of the first, second, third, fourth, fifth, and sixth switches 31, 32, 33, 34, 35, 36 and the driving transistor 40 includes a first end 311, 321, 331, 341, 351, 361, 41, a second end 312, 322, 332, 342, 352, 362, 42, and a control end 313, 323, 333, 343, 353, 363, 43 determining conduction of the first end 311, 321, 331, 341, 351, 361, 41 and the second end 312, 322, 332, 342, 352, 362, 42. In this embodiment, each of the first, second, third, fourth, fifth, and sixth switches 31, 32, 33, 34, 35, 36 and the driving transistor 40 is an N-type thin-film transistor. The control end 313, 323, 333, 343, 353, 363, 43 of each of the first, second, third, fourth, fifth, and sixth switches 31, 32, 33, 34, 35, 36 and the driving transistor 40 is the gate of the N-type thin-film transistor. The first end 311, 321, 331, 341, 351, 361, 41 of each of the first, second, third, fourth, fifth, and sixth switches 31, 32, 33, 34, 35, 36 and the driving transistor 40 is the source or the drain of the N-type thin-film transistor. The second end 312, 322, 332, 342, 352, 362, 42 of each of the first, second, third, fourth, fifth, and sixth switches 31, 32, 33, 34, 35, 36 and the driving transistor 40 is the drain or the source of the N-type thin-film transistor. The second end 312, 322, 332, 342, 352, 362, 42 is different from the first end 311, 321, 331, 341, 351, 361, 41.

The first end 311 of the first switch 31, the second end 332 of the third switch 33, the first end 351 of the fifth switch 35, and the first capacitor end 51 of the capacitor 50 are electrically connected to a first node PD.

The second end 312 of the first switch 31 and the first end 321 of the second switch 32 are electrically connected to an initialization voltage Vinit.

The control end 313 of the first switch 31 and the control end 323 of the second switch 32 are electrically connected to a first scan line Scan-_n-1.

The second end 322 of the second switch 32 and the second end 342 of the fourth switch 34 are electrically connected to the anode 21 of the organic light-emitting diode 20.

The first end 331 of the third switch 33, the second end 362 of the sixth switch 36, and the control end 43 of the driving transistor 40 are electrically connected to a second node PG.

The control end 333 of the third switch 33 and the control end 343 of the fourth switch 34 are electrically connected to an emission line Emit n.

The first end 341 of the fourth switch 34, the second end 42 of the driving transistor 40, and the second capacitor end 52 of the capacitor 50 are electrically connected to a third node PS.

The second end 352 of the fifth switch 35 is electrically connected to a data voltage V_{data}.

The control end 353 of the fifth end 35 and the control end 363 of the sixth switch 36 are electrically connected to a second scan line Scan_n.

The first end 361 of the sixth switch 36 is electrically connected to a sustaining voltage VSUS.

The first end 41 of the driving transistor 40 is electrically connected to a first power voltage VDD (namely, a positive terminal of the power).

The connection of main components of the embodiment according to the present invention is hereinbefore described. The operation and effects of the present invention will be set forth hereinafter.

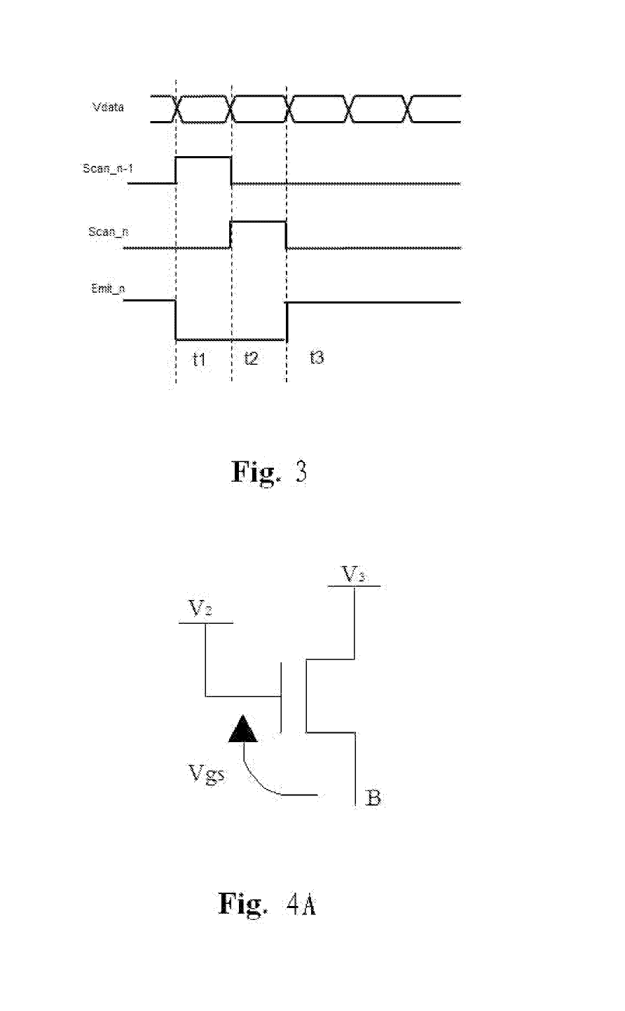

Please refer to FIGS. 2 and 3. FIG. 3 is a timing program of the pixel circuit for an active-matrix organic light-emitting diode display according to the present invention. The circuitry diagram of the pixel circuit according to the present invention can be divided into three states respectively controlled by the first scan line Scan-_n-1, the second scan line Scan_n, and the emission line Emit_n to be in a reset state of a first stage t1, a compensation state of a second stage t2, and an emission state of a third stage t3.

In the reset state of the first stage t1, only the first scan line Scan-_n-1 is at the high level, and the first switch 31 and the second switch 32 are conductive. Thus, the charges stored in the capacitor 50 and the parasitic capacitor of the organic light-emitting diode 20 are cleaned.

In the compensation state of the second stage t2, only the second scan line Scan_n is at the high level, and the fifth switch 35 and the sixth switch 36 are conductive. In this case, the voltage of the first node PF is the data voltage V_{data}. The voltage of the second node PG is the sustaining voltage VSUS. The voltage of the third node PS is VSUS−Vₜₕ, wherein Vth is the threshold voltage of the driving transistor 40. The threshold voltage Vₜₕ of the driving transistor 40 is read. The voltage of the first and second capacitor ends 51 and 52 of the capacitor 50 is V_{data}−(VSUS−Vₜₕ), namely, the voltage of the first node PD minus the voltage of the third node PS. At this time, the compensation voltage stored in the capacitor 50 has completely compensated the threshold voltage Vₜₕ of the driving transistor 40.

In the emission state of the third stage t3, only the threshold voltage Vₜₕ is at the high level, and the third switch 33 and the fourth switch 34 are conductive. Thus, the electric current flowing through the driving transistor 40 and the organic light-emitting diode 20 is controlled by the voltage V_{data}−VSUS+Vₜₕ between the first and second capacitor ends 51 and 52 of the capacitor 50. Since both of the first scan line Scan-_n-1 and the second scan line Scan_n are at the low level, the electric current I flowing through the driving transistor 40 and the organic light-emitting diode 20 is proportional to V_{data}−VSUS+Vₜₕ−Vₜₕ. After cancelling out Vₜₕ, the electric current I flowing through the driving transistor 40 and the organic light-emitting diode 20 is proportional to V_{data}−VSUS, which is irrelevant to the threshold voltage Vₜₕ of the driving transistor 40. Namely, the change of the threshold voltage Vₜₕ of the driving transistor 40 does not affect the electric current I finally flowing through the organic light-emitting diode 20.

Thus, the present invention can indeed compensate the variance of the threshold voltage Vₜₕ of the driving transistor 40 such that the electric current I flowing through the organic light-emitting diode 20 can precisely be controlled without influence from the threshold voltage Vₜₕ of the driving transistor 40, increasing the luminance uniformity and stability of the display.

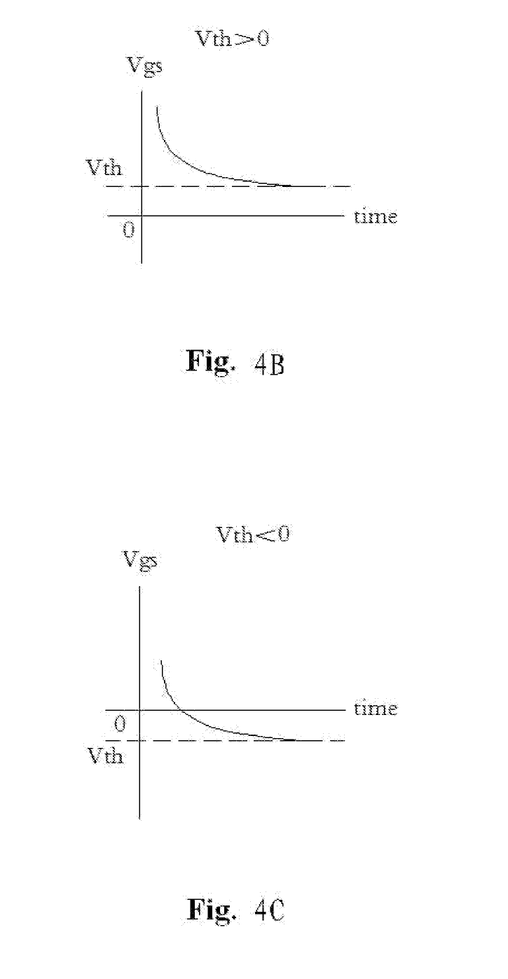

Furthermore, as can be seen from FIGS. 4A, 4B, and 4C, the present invention can be applied to a depletion mode driving transistor 40 (i.e., an oxide TFT). Thus, the threshold voltage Vₜₕ can be obtained to proceed with compensation no matter the threshold voltage Vₜₕ of the driving transistor 40 is larger or smaller than zero.

Note that the present invention provides a pixel circuit for an active-matrix organic light-emitting diode display, including an organic light-emitting diode 20 and a driving circuit. The driving circuit includes an initialization module, a signal voltage writing module, and a light-emitting display module. The features include:

The driving circuit further includes a threshold voltage compensation module. The threshold voltage compensation module includes a sixth switch 36 and a driving transistor 40. The sixth switch 36 is used to obtain the threshold voltage Vₜₕ of the driving transistor 40 and to proceed with compensation of a variation of the threshold voltage Vₜₕ, precisely controlling the electric current I in the light-emitting display module flowing through the organic light-emitting diode 20.

The initialization module includes the first switch 31 and the second switch 32. The signal voltage writing module includes the fifth switch 35. The light-emitting display module includes the third switch 33, the fourth switch 34, and the capacitor 50 having the first capacitor end 51 and the second capacitor end 52.

The invention has been described in connection with the embodiments shown in the accompanying drawings though, a person having ordinary skill in the art can make various modifications to the invention based on the above descriptions. Therefore, some details of the embodiment should not be construed to restrict the invention. The scope of the invention is limited by the accompanying claims.

1. A pixel circuit for an active-matrix organic light-emitting diode display, comprising an organic light-emitting diode and a driving circuit, with the driving circuit including an initialization module, a signal voltage writing module, and a light-emitting display module, wherein the improvements comprise:
the driving circuit further includes a threshold voltage compensation module, the threshold voltage compensation module includes a sixth switch and a driving transistor, and the sixth switch is used to obtain a threshold voltage of the driving transistor and to proceed with compensation of a variation of the threshold voltage, precisely controlling an electric current in the light-emitting display module flowing through the organic light-emitting diode.

2. The pixel circuit for an active-matrix organic light-emitting diode display according to claim 1, wherein the initialization module includes a first switch and a second switch, the signal voltage writing module includes a fifth switch, and the light-emitting display module includes a third switch, a fourth switch, and a capacitor having a first capacitor end and a second capacitor end,
wherein each of the first, second, third, fourth, fifth, and sixth switches and the driving transistor includes a first end, a second end, and a control end determining conduction of the first end and the second end,
wherein the first end of the first switch, the second end of the third switch, the first end of the fifth switch, and the first capacitor end of the capacitor are electrically connected to a first node,
wherein the second end of the first switch and the first end of the second switch are electrically connected to an initialization voltage,
wherein the control end of the first switch and the control end of the second switch are electrically connected to a first scan line,
wherein the second end of the second switch and the second end of the fourth switch are electrically connected to an anode of the organic light-emitting diode,
wherein the first end of the third switch, the second end of the sixth switch, and the control end of the driving transistor are electrically connected to a second node,
wherein the control end of the third switch and the control end of the fourth switch are electrically connected to an emission line,
wherein the first end of the fourth switch, the second end of the driving transistor, and the second capacitor end of the capacitor are electrically connected to a third node,
wherein the second end of the fifth switch is electrically connected to a data voltage,
wherein the control end of the fifth end and the control end of the sixth switch are electrically connected to a second scan line,
wherein the first end of the sixth switch is electrically connected to a sustaining voltage, and
wherein the first end of the driving transistor is electrically connected to a first power voltage.

3. The pixel circuit for an active-matrix organic light-emitting diode display according to claim 2, wherein each of the first, second, third, fourth, fifth, and sixth switches and the driving transistor is an N-type thin-film transistor.

4. The pixel circuit for an active-matrix organic light-emitting diode display according to claim 3, wherein the control end of each of the first, second, third, fourth, fifth, and sixth switches and the driving transistor is a gate of the N-type thin-film transistor.

5. The pixel circuit for an active-matrix organic light-emitting diode display according to claim 3, wherein the first end of each of the first, second, third, fourth, fifth, and sixth switches and the driving transistor is a source or a drain of the N-type thin-film transistor, wherein the second end of each of the first, second, third, fourth, fifth, and sixth switches and the driving transistor is the drain or the source of the N-type thin-film transistor, and wherein the second end is different from the first end.

6. A pixel circuit for an active-matrix organic light-emitting diode display, comprising:
an organic light-emitting diode including an anode and a cathode electrically connected to a second power voltage; and
a driving circuit including a first switch, a second switch, a third switch, a fourth switch, a fifth switch, a sixth switch, a driving transistor, and a capacitor, with the capacitor including a first capacitor end and a second capacitor end,
wherein each of the first, second, third, fourth, fifth, and sixth switches and the driving transistor includes a first end, a second end, and a control end determining conduction of the first end and the second end,
wherein the first end of the first switch, the second end of the third switch, the first end of the fifth switch, and the first capacitor end of the capacitor are electrically connected to a first node,
wherein the second end of the first switch and the first end of the second switch are electrically connected to an initialization voltage,
wherein the control end of the first switch and the control end of the second switch are electrically connected to a first scan line,
wherein the second end of the second switch and the second end of the fourth switch are electrically connected to the anode of the organic light-emitting diode,
wherein the first end of the third switch, the second end of the sixth switch, and the control end of the driving transistor are electrically connected to a second node,
wherein the control end of the third switch and the control end of the fourth switch are electrically connected to an emission line,
wherein the first end of the fourth switch, the second end of the driving transistor, and the second capacitor end of the capacitor are electrically connected to a third node,
wherein the second end of the fifth switch is electrically connected to a data voltage,
wherein the control end of the fifth end and the control end of the sixth switch are electrically connected to a second scan line,
wherein the first end of the sixth switch is electrically connected to a sustaining voltage, and
wherein the first end of the driving transistor is electrically connected to a first power voltage.

7. The pixel circuit for an active-matrix organic light-emitting diode display according to claim 6, wherein each of the first, second, third, fourth, fifth, and sixth switches and the driving transistor is an N-type thin-film transistor.

8. The pixel circuit for an active-matrix organic light-emitting diode display according to claim 7, wherein the control end of each of the first, second, third, fourth, fifth, and sixth switches and the driving transistor is a gate of the N-type thin-film transistor.

9. The pixel circuit for an active-matrix organic light-emitting diode display according to claim 7, wherein the first end of each of the first, second, third, fourth, fifth, and sixth switches and the driving transistor is a source or a drain of the N-type thin-film transistor, wherein the second end of each of the first, second, third, fourth, fifth, and sixth switches and the driving transistor is the drain or the source of the N-type thin-film transistor, and wherein the second end is different from the first end.
